(19) United States
(12) Patent Application Publication
(10) Pub. No.: US 2011/0169230 A1
(43) Pub. Date: Jul. 14, 2011

(54) CHUCK FOR TOOLS

(76) Inventor: Gerhard Babel, Baltmannsweiler (DE)

(21) Appl. No.: 12/958,514

(22) Filed: Dec. 2, 2010

(30) Foreign Application Priority Data
Jan. 14, 2010 (DE) 10 2010 004 558.6
Mar. 20, 2010 (DE) 10 2010 013 430.9

(51) Int. Cl. B23B 31/02; B23B 31/20

(52) U.S. Cl. 279/20; 279/46.9

(57) ABSTRACT

A chuck for a tool having an inner coolant channel, comprising a chuck body having a front part with an inner cone; an externally conical collet having a plurality of slots in a longitudinal direction thereof and engaging in the inner cone of the front part of the chuck body, a length adjusting means for the tool arranged so that the tool is bearable via an end surface against the length adjusting means, a coolant supply tube provided with a coolant supply channel extending into the length adjusting means so that the coolant supply tube discharges into the length adjusting means, a lock nut having a sleeve section extending over a front part of the chuck body and retained on the latter in an axially displaceable manner via a threaded connection and also connected to the collar in an axially displaceable manner, and at least one sealing means provided in a contact region selected from the group consisting of a contact region of the coolant supply channel, a contact region of the threaded connection, and a contact region of both.

### CROSS-REFERENCE TO RELATED APPLICATION

The invention described and claimed hereinbelow is also described in German Patent Application DE 10 2010 004 558.6 filed on Jan. 14, 2010. This German Patent Application, whose subject matter is incorporated here by reference, provides the basis for a claim of priority of invention under 35 U.S.C. 119(a)-(d).

### BACKGROUND OF THE INVENTION

The present invention relates to a chuck for tools, in particular those comprising an inner coolant channel e.g. thread-cutting taps.

Chucks of the above-described type are known. The collets typically comprise a plurality of slots in the longitudinal direction thereof. A coolant/lubricant conducted through the chuck body to the tool can emerge from such collets since it has not been possible to seal a chuck of the initially described type in a manner such that the coolant/lubricant conducted therethrough emerges only through the installed tool. Critical regions in which coolant/lubricant conducted therethrough can become lost also exist in the course of the coolant supply channel from the coolant supply tube to the inlet into the inner coolant channel of the tool. An emulsion that is introduced by the chuck into the tool under high pressure, and an aerosol that flows through the chuck into the tool under low pressure can be used as the coolant/lubricant. Although losing emulsion—which is supplied under high pressure—due to leaks would be tolerable due to the high system pressure, the cooling or lubrication would fail if an aerosol—which is supplied under low pressure—would leak.

### SUMMARY OF THE INVENTION

It is therefore an object of the invention to create a chuck for tools of the type described initially, which is sealed in a manner that ensures that the coolant/lubricant conducted therethrough emerges exclusively through the installed tool.

In keeping with this object, according to the invention, in the chuck sealing is provided o contact regions of the coolant supply channel and/or the threaded connection between the front part of the chuck body and the sleeve section of the locknut using at least one sealing ring.

Due to the at least one sealing ring, it is ensured that no coolant/lubricant emerges from anywhere in the coolant supply channel and/or despite the use of the slotted collet, and instead reaches the outside only through the installed tool.

It is thereby ensured that all the advantages of using an aerosol, which is supplied under low pressure, can be realized when coolant is supplied internally through the tool and/or if a radially slotted collet is used.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic axial longitudinal sectional view of a chuck with a collet and a tool retained therein in accordance with the present invention;

FIG. 2 shows an enlarged longitudinal sectional view of a detail of the chuck shown in FIG. 1 in accordance with the present invention.

### DESCRIPTION OF THE PREFERRED EMBODIMENTS

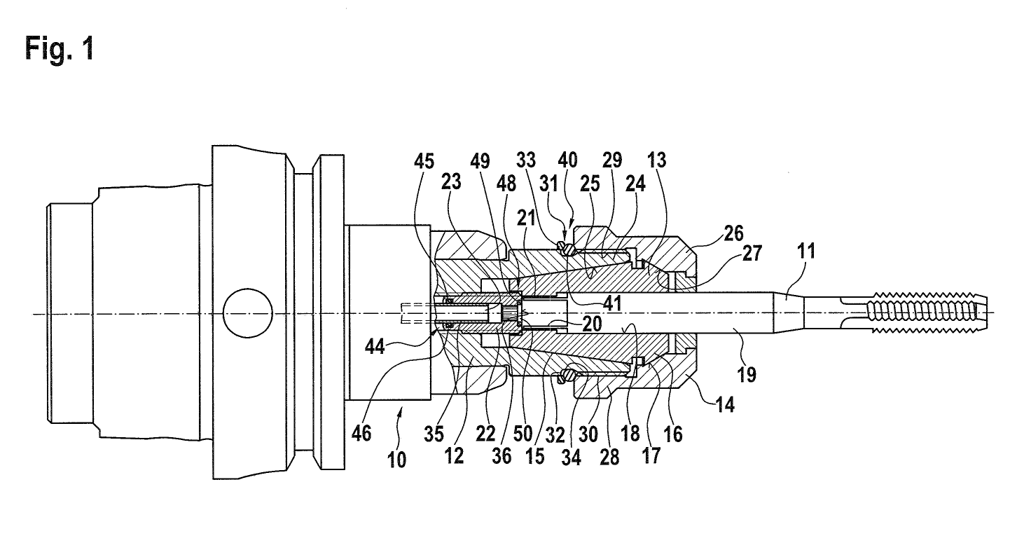

The drawings show schematic views of a chuck 10 for tools 1, which comprises a chuck body 12, a collet 13, and a locknut 14 screwed onto chuck body 12, and is therefore of the conventional type. A thread-cutting tap is shown as an example of a tool 11 in FIG. 1. It preferably comprises an inner coolant channel which is not visible and through which a coolant/lubricant is conducted. This coolant/lubricant may be designed as an emulsion and is conducted through chuck body 12 and into tool 11 under high pressure. The coolant/lubricant may also be composed of an aerosol that flows through chuck body 12 into tool 11 under low pressure. This is referred to as minimum quantity lubrication.

Collet 13 typically comprises a plurality of slots in the longitudinal direction thereof and has a conical external shape, conical section 15 extending along a substantial length of collet 13. On the front end, collet 13 comprises a head 16 having a conical surface 17 that extends in the opposite direction. Collet 13 has an inner seat 18 that is coaxial with chuck body 12 and into which tool 11 is inserted using a cylindrical shaft 19 having a polygon 20 on the end thereof, which is accommodated in a form-fit manner in a polygonal seat 21 at the end of seat 18 and therefore transmits torque.

Tool 11 bears, on the end thereof via an end surface 36, against a length adjusting means 22 e.g. in the form of an adjusting screw that defines the insertion depth and which is provided with an inner coolant supply channel 23 similar to tool 11. The contact can be a metallic planar contact with resultant sealing, or a sealing ring 48 e.g. in the form of a sealing ring 49 e.g. an O-ring is situated axially between length adjusting means 22 and end surface 36, and is accommodated e.g. in a keyway 50 on the end face of length adjusting means 22.

Chuck body 12 includes a substantially cylindrical front part 24 that forms an inner cone 25 which matches conical section 15 of collet 13 and is used as a seat thereof. Locknut 14 comprises a front annular part 26 with inner cone 27, which is assigned to head 16 and conical surface 17 thereof and interacts with conical surface 17 of collet 13 to radially clamp or release collet 13. Locknut 14 comprises an approximately cylindrical sleeve section 28 which abuts annular part 26 and extends over front part 24 of chuck body 12. Sleeve section 28 comprises an inner thread 29 which is used to screw sleeve section 28 onto an external thread 30 of front part 24. Internal thread 29 and external thread 30 establish a threaded connection between locknut 14 and front part 24 of chuck 12 and is used to connect locknut 14 to collet 13 in an axially adjustable and axially displaceable manner.

Threaded connection 29, 30 is sealed using a sealing device 40. Sealing device 40 seals radially and/or axially. It functions between sleeve section 28 of locknut 14 and front part 24 of chuck body 12 and form a radial and axial seal, thereby ensuring that coolant/lubricant conducted therethrough emerges only through installed tool 11, regardless of whether an internal coolant supply of the initially described type uses an emulsion delivered under high pressure or minimum quantity lubrication using an aerosol delivered under low pressure.

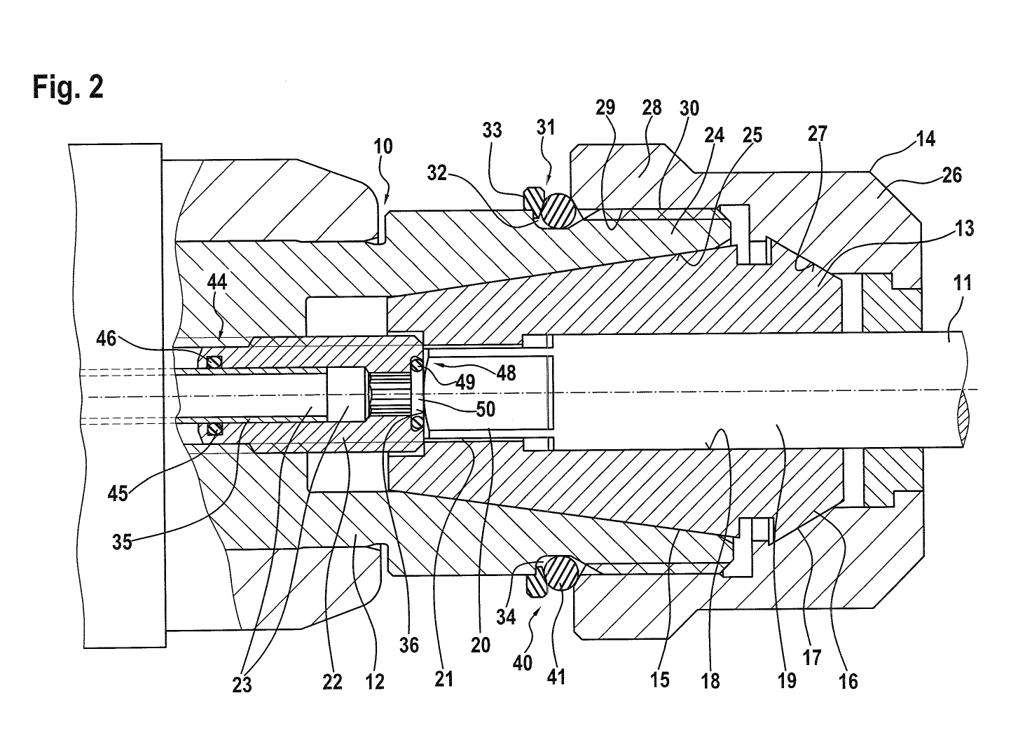

Sealing device 40 is disposed on one of the axial end regions of threaded connection 29, 30, in fact being disposed on the rear end region of threaded connection 29, 30 in the embodiment shown. Sealing device 40 comprises a sealing ring 41 which is composed e.g. of an O-ring. The arrangement can be designed such that front part 24 of chuck body 12 and/or sleeve section 28 of locknut 14 comprise an axial stop for sealing device 40, in particular sealing ring 41. In the embodiment shown, at least one such axial stop 31 is provided on front part 24. A radially overhanging shoulder 32 on front part 24 can suffice as the axial stop. FIG. 2 shows an axial stop 31 in the form of a ring 33. In the embodiment shown, both are part of front part 24. According to another embodiment, which is not depicted, an axial stop 31 can also be provided on the end of sleeve section 28.

Front part 24 of chuck body 12 and/or sleeve section 28 of locknut 14 can be provided with an annular recess in which sealing device 40, in particular sealing ring 41, is accommodated via at least one part of the cross section thereof. In the embodiment shown, such an annular recess 34 is provided on front part 24 of chuck body 12. Sealing ring 41 is accommodated in annular recess 34 radially, with a cross-sectional part recessed, and is thereby held captive. Sleeve section 28 of locknut 14 bears via rear end thereof, which is adjacent to the left—as shown in the drawing—end region of threaded connection 29, 30, against sealing ring 41 and acts thereupon axially and/or radially relative to front part 24 of chuck body 12.

This forms a seal at the rear end of threaded connection 29, 30 and ensures that no coolant/lubricant can pass through collet 13 to the outside. According to another embodiment which is not depicted, sealing ring 41 is instead disposed on the front end of threaded connection 29, 30 and thereby likewise reliably seals the region between locknut 14 and front part 24 of chuck body 12.

According to another embodiment which is not shown, sealing device 40 is disposed between threaded connection 29, 30 and provides the same advantage.

As shown, coolant supply channel 23 is formed inside a coolant tube 35 and length adjusting means 22, into which coolant supply tube 35 discharges. The coolant/lubricant, particularly in the form of an aerosol when minimum quantity lubrication is applied, is supplied via coolant supply tube 35 from a source, which is not depicted, and reaches an inner coolant channel of tool 11, which is not shown, via length adjusting means 22. Coolant supply tube 35 and length adjusting means 22 can be moved axially relative to one another.

A gap is present between the outer surface of coolant supply tube 35 and the inner side of length adjusting means 22. Due to the supply pressure, the coolant and/or lubricant could pass through this gap to the outside of coolant supply tube 35 or length adjusting means 22. This is prevented by a sealing device 44 between length adjusting means 22 and coolant supply tube 35. Sealing device 44 is composed of a sealing ring 46 e.g. an O-ring. It is provided between the outer surface of coolant supply tube 35 and the inner side of length adjusting means 22. A seat, e.g. in the form of an annular groove, is provided on the inner side of length adjusting means 22, in which sealing device 44, in particular sealing ring 46, is accommodated, thereby enabling the latter to bear against the outer surface of coolant supply tube 35 in the radial direction for sealing.

A thusly sealed chuck is simple and cost-favorable, and operates reliably with regard to sealing device 40, 44, 48. By way of the particular sealing device, a radial and axial seal is ensured such that the coolant/lubricant conducted therebetween always emerges only through installed tool 11.

It will be understood that each of the elements described above, or two or more together, may also find a useful application in other types of constructions differing from the types described above.

While the invention has been illustrated and described as embodied in a chuck for tools, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A chuck for a tool having an inner coolant channel, comprising a chuck body having a front part with an inner cone; an externally conical collet having a plurality of slots in a longitudinal direction thereof and engaging in said inner cone of said front part of said chuck body; a length adjusting means for the tool arranged so that the tool is bearable via an end surface against said length adjusting means; a coolant supply tube provided with a coolant supply channel extending into said length adjusting means so that said coolant supply tube discharges into said length adjusting means; a lock nut having a sleeve section extending over said front part of said chuck body and retained on the latter in an axially displaceable manner via a threaded connection and also connected to said collet in an axially displaceable manner; and at least one sealing means provided in a contact region selected from the group consisting of a contact region of said coolant supply channel, a contact region of said threaded connection, and contact regions of both.

2. The chuck for a tool as defined in claim 1, wherein said sealing device functions between said sleeve section of said locknut and said front part of said chuck body.

3. The chuck for a tool as defined in claim 1, wherein said sealing device is formed so that it seals in a manner selected from the group consisting of radially, axially, and both.

4. The chuck for a tool as defined in claim 1, wherein said sealing device is provided between said threaded connection.

5. The chuck for a tool as defined in claim 1, wherein said sealing device is disposed at one axial end region of said threaded connection.

6. The chuck for a tool as defined in claim 1, wherein said sealing device is disposed at the axial region which is a rear end region of said threaded connection.

7. The chuck for a tool as defined in claim 1, further comprising an axial stop provided for said sealing device in an element selected from a group consisting of said front part of said chuck body, said sleeve section of said locknut, and both.

8. The chuck for tool as defined in claim 1, wherein an element selected from the group consisting of said front part of said chuck body, said sleeve section of said locknut, and both has an annular recess in which said sealing device is accommodated via at least one part of a cross section.

9. The chuck for a tool as defined in claim 1, wherein said sleeve section of said locknut has a rear end adjacent to an end region of said threaded connection and bears via said rear end against said sealing device and also acts on said sealing device in a manner selected from the group consisting of axially, radially, and both in a direction toward said front part of said chuck body.

10. The chuck for a tool as define in claim 1, wherein said sealing device is provided between said length adjusting means and said coolant supply tube.

11. The chuck for a tool as defined in claim 1, wherein said sealing device is provided between an outer surface of said cooling supply tube and an inner side of said length adjusting means.

12. The chuck for a tool as defined in claim 1, wherein said sealing device is contained in a seat on an inner side of said length adjusting means and bears against an outer surface of said coolant supply tube.

13. The chuck for a tool as defined in claim 1, wherein said sealing device has a seal formed by a planar contact provided axially between said length adjusting means and an end surface of said tool.

14. The chuck for a tool as defined in claim 13, wherein said sealing device is provided axially between said length adjusting means and said end surface of the tool.

15. The chuck for a tool as defined in claim 1, wherein said sealing device includes a sealing ring.

16. The chuck for a tool as defined in claim 15, wherein said sealing ring of said sealing device is an O-ring.
